(19) United States
(12) Patent Application Publication
(10) Pub. No.: US 2015/0005908 A1
(43) Pub. Date: Jan. 1, 2015

(54) Method and Apparatus for Automatic Ambient Device Control

(71) Applicant: Kambiz Tom Kalili, Beverly Hills, CA (US)

(72) Inventor: Kambiz Tom Kalili, Beverly Hills, CA (US)

(21) Appl. No.: 13/928,304

(22) Filed: Jun. 26, 2013

(51) Int. Cl. G05B 15/02

(52) U.S. Cl. CPC G05B 15/02
USPC 700/90

(57) ABSTRACT

A method and apparatus for automatic ambient device control. The devices to be controlled automatically include, but are not limited to, an electronic lock, smart glass, light fixtures, ambient temperature regulator, such as a thermostat, and an ambient light regulator. Furthermore, in one embodiment of the method and apparatus or automatic ambient device control, it will be capable of product key tracking

### CROSS-REFERENCE TO RELATED APPLICATIONS

This application claims the benefit of U.S. Provisional Application No. 61/664,617, filed on Jun. 26, 2012.

### BACKGROUND

The following is a tabulation of some prior art that presently appears relevant:

### U.S. Patents

| Patent Number | Issue Date | Patentee |
|---|---|---|
| 7,081,806 | July 2006 | Koike |
| 7,796,012 | September 2010 | Gerstenkorn |

### U.S. Patent Application Publications

| Publication Number | Publ. Date | Applicant |
|---|---|---|
| 2004/0219903 | November 2004 | Despain et al. |
| 2006/0106727 | May 2006 | Yellai et al. |
| 2007/0109103 | May 2007 | Jedrey et al. |
| 2007/0159297 | July 2007 | Paulk et al. |
| 2009/0018963 | January 2009 | Abu-Amara |
| 2009/0225989 | September 2009 | Koike |

### Foreign Patent Document

None Found

### Nonpatent Literature Documents

None found

### NOTICE OF COPYRIGHT AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### DISCUSSION OF THE RELATED ART

Modern technology, and more particularly consumer electronic devices, continue to take the place of tasks customarily done manually or mechanically. When in the past consumers had to swipe their credit card to use it in a transaction, said consumer can now accomplish that same task by bringing their smart telephone within range of a wireless credit card reader. With that, gone are the days when consumers would have to carry a wallet full of credit cards to process transactions on.

Technologic improvements in the form of applications and near field of wireless communication devices have enabled their users to store all the necessary credit card information on a wide variety of mobile electronic devices. However, none of the applications heretofore known have been able to accomplish the same objective with keys and electronic key readers.

Therefore, it would be desirous to have such an application that would eliminate the need for a user to carry around a pocket full of keys on a keychain. Moreover, there is a need for an application that would enable the user's mobile electronic device to automatically and wirelessly communicate with a wide variety of the of ambient devices commonly found in dwelling places. The following invention effectuates these needs.

### SUMMARY

In accordance with one embodiment, a method and apparatus for automatic ambient device control. The devices to be controlled automatically include but are not limited to: an electronic lock, smart glass, light fixtures, ambient temperature regulator, ambient light regulator, such as a thermostat. Furthermore, in one embodiment of the method and apparatus or automatic ambient device control, it will be capable of product key tracking.

The inventor envisions a software application which by be uploaded onto a mobile electronic device which then enables said device to communicate wirelessly with a wide variety of electronics commonly found in people's homes. Such electronic devices include but are not limited to light fixtures, thermostats, home theater systems, and smart glass.

The inventor further envisions enabling said mobile electronic device to be used as a means of locking and unlocking doors. Whether it be the lock on the front door of a user's house or the garage door, having this application installed into said mobile electronic device, will allow users to automatically open these doors, without using a key, by coming within a preset distance from the door.

By way of example and not limitation, said mobile electronic device may be a smart phone such as an iPhone or Samsung Galaxy or a tablet PC such as an iPad or Amazon Kindle. Any mobile electronic device capable of having applications installed on it, such as mobile electronic devices running on Windows and Google platforms, are a foreseeable means of using said application.

The description of the invention which follows, together with the accompanying drawings should not be construed as limiting the invention to the example shown and described, because those skilled in the art to which this invention pertains will be able to devise other forms thereof within the ambit of the appended claims.

### DETAILED DESCRIPTION

Illustrative embodiments of the invention are described below. The following explanation provides specific details for a thorough understanding of an enabling description for these embodiments. One skilled in the art will understand that the invention may be practiced without such details. In other instances, well-known structures and functions have not been shown or described in detail to avoid unnecessarily obscuring the description of the embodiments.

Various communication means are envisioned. By way of example and not limitation, the different forms of communication may be Robotic technology utilizing voice, heat, motion, sound, sensory and or color commands.

In another embodiment, laser technology may be used as a communication means. Recently being tested in automobiles for navigation and video technology, this may be a component of the method and apparatus for automatic ambient device control as well. Laser may be utilized in key-lock technology where the magnetic field on the application eliminates interferences seen in radio frequencies. Laser does not rely on reception as does radio since laser can have an imbedded chip within the card to allow clear communicates with the magnetic strip to activate and or de-activate lock to open.

In yet another embodiment, near field communication (NFC) may be used as a means of sending and receiving.—An additional mode of communication may be NFC which is compatible with, but not limited to, Bluetooth and Radio field communication (RFID) which is presently being utilized in major hotels via the magnetic strip cards.

When the remote handheld device (smartphone) receives an activating device in response to the electronic lock, the smartphone is enabled to lock and unlock the electronic lock when transmitted, using technology referenced above and to include, but not limit to, NFC technology with control of time, date of activation capabilities; and Send “key” to remote user and deactivate with specific parameters by main user.

Various means of displaying information are also envisioned._The method and apparatus for automatic ambient device control includes a digital/laser display readout command screen that links in with the navigation function available on many modern smartphones which draws on laser technology in DVD and Blu-ray.

The display enables the user to activate various locks by simply selecting the lock/security and clicking on the specific lock which will enable lock/security system to open.

In one embodiment, the search and find screen can be a readout, voice, sensory and or heat activated command to simply retrieve the lock whether at home, office, business, security locations in schools or banks and activate the system to open or close.

A variety of means for authenticating the user of a given mobile electronic device are envisioned. These means will ensure said device will be incapable of opening a door or engaging any of the ambient devices should it get lost or stolen. The aforementioned means include, but are not limited to voice, heat, sense, memory, pattern (pattern is built into the programming based on the pattern of user which continues to build with use) touch, sound, memory controls.

In one embodiment, authentication can be accomplished on-sight, while in another embodiment is may be from a remote location.

Temperature and lighting regulation are additionally features of the present invention. Temperature and light may be regulated in two ways using the method and apparatus for automatic ambient device control.

In one embodiment, temperature and light may be controlled remotely by communicating wirelessly with the thermostat and light regulation and adjust based on user preference desired light and thermal setting on his/her hand held device. This can be set by user for various rooms in home, office and other settings. Thereafter, once set at a given degree, the communication between hand held device and the source of heat and light will be automatically communicating remotely and automatically such as the heart and respiratory system: involuntary.

Second source of regulation would be utilizing the advancements of smart glass. Smart glass, EGlass, or switchable glass, also called smart windows or switchable windows in its application to windows or skylights, refers to electrically switchable glass or glazing which changes light transmission properties when voltage is applied.

Certain types of smart glass allow users to control the amount of light (and thereby heat) transmission. When activated, the glass changes from transparent to translucent, partially blocking light while maintaining a clear view through the glass.

Another type of smart glass can provide complete privacy when activated thereby giving privacy to the user when searching for a particular key, entering secured password protected functions to activate a key.

Further, the features of a smart glass enable user to benefit from utilizing temperature changes to achieve various functions such as lock activation, auto regulation of temperature while at home, office or on vacation at a hotel.

The temperature change capability of the smart glass triggers an auto regulated climate control of one's environment and engages with the temperature regulating system at the location whether home, work, in the car or at a hotel. Smart glass technologies include electrochromic devices, suspended particle devices, micro-blinds and liquid crystal devices.

In one embodiment of the present invention, temperature and light may be utilized as a means of triggering given commands eliciting action from the method and apparatus.

In one such embodiment, the method and apparatus may be used for maintaining visibility of the smartphone screen even under low light or no light conditions. This can be achieved using smart glass technology. Electrochromic glass provides visibility even in the darkened state and thus preserves visible contact with the outside environment.

The inventor contemplates using this technology for increased visibility when in low light as a user is approaching their home, office, business or any secured location where the method and apparatus for automatic ambient device control is required to engage or dis-engage a lock.

The method and apparatus for automatic ambient device control can be used to control and regulate the immediate environment of a user by controlling the smart glass whether placed as windows, skylights or other “glass” required locations. The method and apparatus for automatic ambient device control can then control the amount of light, heat and or temperature coming into or out of the barrier established by the smart glass.

It is one aspect of the method and apparatus that it may be used as a remote. Any key can be remotely sent to other party utilizing security verification parameters and activated for a given date, time and/or duration with instant termination command at will by a primary user or account holder.

The method and apparatus will be useful in the area of product, development manufacturing, distribution, and tracking In this aspect of the method and apparatus for automatic ambient device control is its ability to pick up bar code and other modes of electronic scans or identification labels presently used and to be used in the future to tag products for identification during manufacturing, sales, and distribution for purchase by the end user. This will minimize errors during the entire process from point of inception of developing a product to the point of purchase by the end user. BY way of example and not limitation, during the manufacturing of an item, the phases of development can be tagged and tracked now by a mere hand held device, glasses worn, wrist or waste band or simply secured in various locations in the proximity of each phase of development to allow the process to detect and match eliminating errors of mismatch of one product component to another throughout the manufacturing phase. This will eliminate errors of wrong parts getting associated with a wrong “attachment” i.e.: wrong bumper with the wrong body of a car. Each and every employee can now have a remote hand held device for verification prior to, during and after associating each item with the next.

It is envisioned that in further embodiments, the method and apparatus of the present invention may be used for consumer purchase tracking Presently, products displayed in food markets and other retailers have a bar code label or other forms of price identification attached, adhered or associated for inventory monitoring and sales transactions.

The method and apparatus for automatic ambient device control would be enable a user to scan the bar code or other forms of tagging which consists of the product labeling information of the items being placed for purchase. Thereby a user or consumer can track their purchases prior to final payment for tracking, monitoring and to maintain a statistical analysis of their daily, weekly, monthly and or yearly purchases.

Furthermore, given the user will have all the key information on their routine purchase requests with instant access on their smartphone, they would be able to remotely and wirelessly submit their routine requirements in advance where the distributor or retailer may be able to have the products available for pick up or delivery without ever having to leave one's home, work or play. This would streamline accounting for tax purposes which is compatible and ease of integration with major standalone accounting software packages such as Quicken for tax purposes.

Moreover, the present invention is capable of web-based access and control of all the aforementioned aspects, functionalities, and components heretofore referenced.

The method and apparatus for automatic ambient device control comprises web based capability thereby enabling it to be remotely programmed, accessed and sent from one location to another by “main user” at any time, for any duration, activated and deactivated at will.

By way of example and not limitation, as referenced using the key/lock component of the method and apparatus for automatic ambient device control, if one is desirous of sending a key to a remote business or home location, a “key” access can be submitted via web server to a remote location which can then be download wireless into a smartphone to function for a specific lock, with parameters of specific date, time and duration.

With the lose key no more feature of the present invention, users will no longer have to worry about losing a key as it has sound, sense, pressure, vibration and temperature activation capability from a remote site. Thus, from anyone else's smartphone, one can access their key by inserting their access code and activate a lock to open for a one time use or a controlled number of times and duration without the concern of that second person's smartphone being able to use your key in the future.

Accordingly, the method and apparatus for automatic ambient device control can be remotely from any other smartphone with the mere input of password and security code.

The platform for functionality of the present invention shall include security access by the user. The method and apparatus for automatic ambient device control can function under the following but not limited with respect to functional aspects as referenced above and to include security access limited to main user and or the users assigned by main user. For a user to activate the apparatus for automatic ambient device control and its associated features can be entry by form of heat/thermal, sensory/touch, visual/optical, sound frequency, light/frequency, electromagnetic, electronics, sense, memory, and atomic.

The following are some examples, not meant to be limitations of means for securely accessing the present invention. One such means is fingerprint. The method and apparatus for automatic ambient device control may allow user access to “Key” using their hand held device such as a smartphone by finger print identification by obtaining a voltage graph of a fingerprint from pressed signals of a user logging in via a touch panel of the electronic device. The system detects fingerprint characteristic points in the voltage graph of the fingerprint of the user logging in, and computes fingerprint characteristic values according to the detected fingerprint characteristic points. The system further determines if the computed fingerprint characteristic values match original fingerprint characteristic values an authorized user, and validates identification of the user logging in.

Another means of securely accessing the present invention includes retinal image. The method and apparatus for automatic ambient device control may allow user access to “Key” using their hand held device such as a smartphone in which individual authorization is given by a virtual retinal display.

Yet another means of unlocking and securely accessing the invention is through voice activation. User identification information identifies an active session of operation of the primary user to activate the “Key” features or remotely send the activation clearance to another user.

Touch is another means of unlocking the present invention. The method of managing media files remotely on a portable electronic device having the touch screen display includes a touch security protected access to “Key” accessible both on directly on the hand held device or at a remote computing device. At least one activation touch event is then detected on the touch screen display, and in response to the at least one activation touch event, functions are displayed within the graphical user interface, and user is able to utilize said functions.

In the thermal means of securely accessing the method and apparatus for automatic ambient device a control may comprise a scalable, real-time security access detected by thermal analysis define thermal properties like entropy, temperature and energy for network states and changes in the properties.

In the electronic means of securely accessing the method and apparatus for automatic ambient device, electronic conductivity may be used to activate the platform of the method and apparatus for automatic ambient device control and to allow access by said user at a distance sufficient to induce a change in the electronic conductivity associated with the localized electronic charge thereby activating the method and apparatus for automatic ambient device control to perform functions referenced above.

In the memory recognition means of securely accessing the method and apparatus for automatic ambient device, Pattern is built into the programming based on the pattern of user which continues to build with use, touch, sound, and memory control.

In a memory pattern embodiment, a computer can build unique recognition of patterns by a user and build off of that pattern for prediction of future events. The inventor envisions that the method and apparatus may recognize when a user goes in a room method and apparatus can recognize what was the last temperature, or light intensity desired and automatically offer that as a default option. However, at any time, user can select another option through the search and find features. For example, if a key is in demand, the method and apparatus will recognize which key to offer as a default based on the user's location identified using GPS. GPS is one source and form of location recognition but said user may also scroll and select the desired key on their mobile electronic device. This automated and manual options are also available for temperature, heat and light features of the method and apparatus for automatic device control.

In another embodiment related to shopping, the method and apparatus will recognize which market the items are being scanned at and go into, so the consumer would not even have to search for the key, temperature control or company where he/she wants to perform scanning as the method and apparatus for automatic ambient device control would build a memory and recognize based on user pattern which would be default for each location and or use and at that time the user can replace the default with another key, light or temperature location or business for product scanning

### CONCLUSIONS, RAMIFICATIONS, AND SCOPE

While a particular form of the method and apparatus for automatic ambient device control has been illustrated and described, it will be apparent that various modifications can be made without departing from the spirit and scope of the invention. For example, the ambient temperature regulator may be a traditional thermostat in one example even though the inventor contemplates the possibility that the ambient temperature regulator may also be a wireless internet enabled thermostat such as the Nest learning thermostat.

The teachings provided herein can be applied to other systems, not necessarily the system described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

Particular terminology used when describing certain features or aspects of the invention should not be taken to imply that the terminology is being refined herein to be restricted to any specific characteristics, features, or aspects of the improved method and apparatus for automatic ambient device control with which that terminology is associated. In general, the terms used in the following claims should not be constructed to limit the method and apparatus for automatic ambient device control to the specific embodiments disclosed in the specification, unless the above Detailed Description section explicitly define such terms. Accordingly, the actual scope encompasses not only the disclosed embodiments, but also all equivalent ways of practicing or implementing the disclosed system and method of introducing providers to consumers. The above Detailed Description of embodiments of the method and apparatus is not intended to be exhaustive or limited to the precise form disclosed above or to a particular field of usage. While specific embodiments of, and examples for, the method and apparatus for automatic ambient device control are described above for illustrative purposes, various equivalent modifications are possible which those skilled in the relevant art will recognize.

While certain aspects of the method and apparatus for automatic ambient device control, the inventor contemplate the various aspects of the improved method and apparatus in any number of claim forms. Accordingly, the inventor reserves the right to add additional claims after filing the application to pursue such additional claim forms for other aspects of the system and method for introducing service providers to consumers.

What is claimed is:

1. A method and apparatus for automatically activating and deactivating an electronic “lock” plus “smart glass” regulation of light for key access visibility, temperature control thermo regulator and product key tracking utilizing software installed on a mobile electronic device.

2. The method of claim 1 further comprising a connection interface wherein selecting said connection interface may be any one of a plurality of connection interfaces selected from a list comprises selecting one of an infrared connection interface and a Blue tooth® connection interface.

3. The method and apparatus of claim 1 further comprising a central activating device, wherein said software will be encoded by said central activating device to include the specific parameters in controlling a lock. Said mobile electronic device, once encoded will operate said specific lock for the time period included in the encoding initially preset by said central activating device.

4. The method and apparatus of claim 1, further comprising a central activating device which activates said mobile electronic device to activate and deactivate a door lock based on the pre-programmed settings. Said mobile electronic device will comprise a software program that may be programmed at a reception desk computer or by the party in charge to include the specific lock for a specific room and the duration for which the electronic device may be used to open said room's lock.

5. The method and apparatus of claim 4, wherein said mobile electronic device is activated from a central activating device and receives specific preset activation and deactivation parameters such as time, duration, frequency using NFC technology.

6. The method and apparatus of claim 4, wherein said mobile electronic device utilizes NFC designed to be compatible with all three of the predominant modes of communication: laser, radio field communication, and blue tooth technology.

7. The method and apparatus of claim 4, wherein said mobile electronic device is design so it will be compatible and upgradable as technologies advance using sound, sensory, motion, video and contact information between said device and a lock mechanism to open security doors.

8. The method and apparatus of claim 4, wherein said software may be an application to pick up hotel key programming so one can replace the key using their mobile electronic device.

9. The method and apparatus of claim 1, wherein mobile electronic device and said software is compatible with the major types of lock designs which accept both magnetic stripe cards and smart cards for routine use as well as incorporating a mechanical override key.

10. The method and apparatus of claim 1, wherein said software enables to easily add/remove users, set time restrictions on access and maintain a complete audit trail on usage.

11. The method and apparatus of claim 1, wherein coding may be sent through said mobile electronic device to other mobile electronic devices owned, used or operated by a desired, approved and secured third party also requiring remote access to specific given secure locks selected from a group of one or more of the following controls: Limited time, time and date range or frequency; One time pass with a time period that a user can deactivate key anytime.

12. The method and apparatus of claim 1 wherein said mobile electronic device is associated with a user-defined group and a password that allow said computerized handheld device to connect with said computerized second device to send coded information for activation and deactivation of secured locks based on given parameters such as dates and times.

13. The method and apparatus of claim 1, wherein once said mobile electronic device is encoded, it will operate the specific lock for the time period included pre-programmed within the encoding.

14. The method and apparatus of claim 1, wherein a mobile electronic device may be used to open a lock by waiving said device in front of said lock.

15. The method and apparatus of claim 1, wherein transmitting an activating device to the central activating device comprises one of providing or transmitting an activating device in a short message service SMS text message to a remote mobile device.

16. The method and apparatus of claim 1, wherein an activating said device is based on the primary access code received from the manufacturer of the electronic lock.

17. The method and apparatus of claim 1, wherein a mobile phone may be used a s a central activating device.
